(19) United States
(12) Patent Application Publication
(10) Pub. No.: US 2010/0045191 A1
(43) Pub. Date: Feb. 25, 2010

(54) DEVICE FOR CONTROLLING LIGHT SOURCES

(75) Inventor: Everaard Marie Jozef Aendekerk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,440

(22) PCT Filed: Dec. 17, 2007
(86) PCT No.: PCT/IB07/55146

§ 371 Date: Jun. 16, 2009

(30) Foreign Application Priority Data
Dec. 22, 2006 (EP) 06127070.8

(51) Int. Cl. H05B 37/02

(52) U.S. Cl. 315/152

(57) ABSTRACT

An illumination system (1) comprises: —at least one light source (2); —a control system (3) for controlling the light sources, the control system comprising a sensor system (4) with at least one light sensor (5) for sensing ambient light (L1) and for generating a sensor output signal (M) representing the sensed light level, wherein the control system is designed for controlling the light sources in relation to the sensor output signal. The control system automatically calibrates the sensor system. The control system measures the ambient illumination level (M_{MIN}) at a moment of calibration and stores this measured ambient illumination level into a memory (7). The control system, preferably with the light sources in an OFF condition, monitors the ambient illumination level and compares this with the stored value, and automatically performs a calibration procedure when the ambient illumination level reaches a new minimum value lower than the stored value.

### FIELD OF THE INVENTION

The present invention relates in general to the field of controlling illumination in a room. More particularly, the invention relates to a control system capable of regulating the light sources such as to maintain a certain constant illumination level, and/or capable of switching light sources on or off in response to detecting presence to absence of persons in a room. Such control system is, for instance, useful in an office, where it is desirable that an office worker has a constant light level on a desk, and the present invention will be explained in more detail for such application, but it is to be noted that the invention is not restricted to this application.

### BACKGROUND OF THE INVENTION

In a room where it is desirable that the illumination level is kept constant, light sources may be dimmed or even switched off in sunny circumstances when much daylight enters the room, and the light sources should be turned on or increased to a higher output level as it gets darker. For being able to effect such control characteristic, a control system comprises a sensor system which measures the ambient illumination level. Such sensor system receives light reflecting from surfaces like, for instance, a desk top.

### SUMMARY OF THE INVENTION

A problem is that, even when the ambient light level remains constant, the light intensity as “seen” by the sensor system may vary with varying circumstances in the room. The amount of light received by the sensor system depends on the reflection coefficients of objects in the room, which in turn depend on the situation in the room, such as for instance the presence or absence of office furniture, the colour of the office furniture, etc. Since these reflection coefficients thus depend on the location of application and are therefore unpredictable, it is required that a sensor system is calibrated after having been newly installed. Thus, the sensor system is capable of being operated in a calibration mode. Calibration is, up to now, done by having the sensor system take a measurement with all the lights OFF, preferably in a condition without daylight, and having the sensor take a measurement with all the lights ON; the difference corresponds to the installed light power in the room, which is known (for typical office applications, this level is 500 lux).

To date, such calibration procedure is done by hand during the evening. Normally, such sensor is mounted against the ceiling, and an operator performing the calibration procedure has to manually switch the lights ON and OFF and has to manually bring the sensor in its calibration mode. For this purpose, a sensor is provided with a calibration button which needs to be pressed by the operator, which requires that he has to climb a ladder to approach the sensor, and then he has to remove the ladder and his own person in order not to disturb the actual reflection coefficients (alternatively, the sensor is provided with a remote control, but this is more expensive). This procedure has to be repeated for each sensor. Further, in most cases the operator has to wait until it is dark outside. All in all, this calibration procedure is a rather cumbersome procedure.

An object of the present invention is to eliminate or at least reduce the above problems.

More particularly, the present invention aims to provide a sensor system capable of automatic calibration.

In a sensor provided with automatic calibration facility, the actual calibration procedure can remain the same. The important aspect for the sensor is to define a suitable moment for performing the calibration procedure.

According to the present invention, a sensor system is arranged for recognizing a moment when it is dark outside. The recognition procedure is based on the fact that the outside light normally has a day/night pattern with the light level being at a minimum during the night. Thus, the system according to the present invention monitors the illumination level as a function of time, and when the illumination level reaches a minimum the sensor assumes that it is dark. In a preferred embodiment, the light sources are switched OFF. This corresponds to normal situations, where during the evening an office is deserted and the lights are OFF, and where it gets dark as the sun sets until, the next morning, the outside light level increases again with the rising of the sun.

Further advantageous elaborations are mentioned in the dependent claims.

It is noted that DE-196.06674 discloses a method where an automatic calibration is performed at a predetermined time, wherein at least one light source is used as a reference source. However, using a fixed predetermined time does not guarantee actual darkness. Further, using one light source as reference light source implies that it is not possible to perform an absolute measurement of the illumination level.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 schematically shows a room with an illumination system according to the present invention;

FIG. 2 is a block diagram schematically illustrating a control system with a sensor system;

FIG. 3 is a flow diagram illustrating the operation of the sensor system for initiating a calibration procedure;

FIG. 4 is a flow diagram illustrating the operation of the sensor system for initiating another calibration procedure.

### DETAILED DESCRIPTION OF THE INVENTION

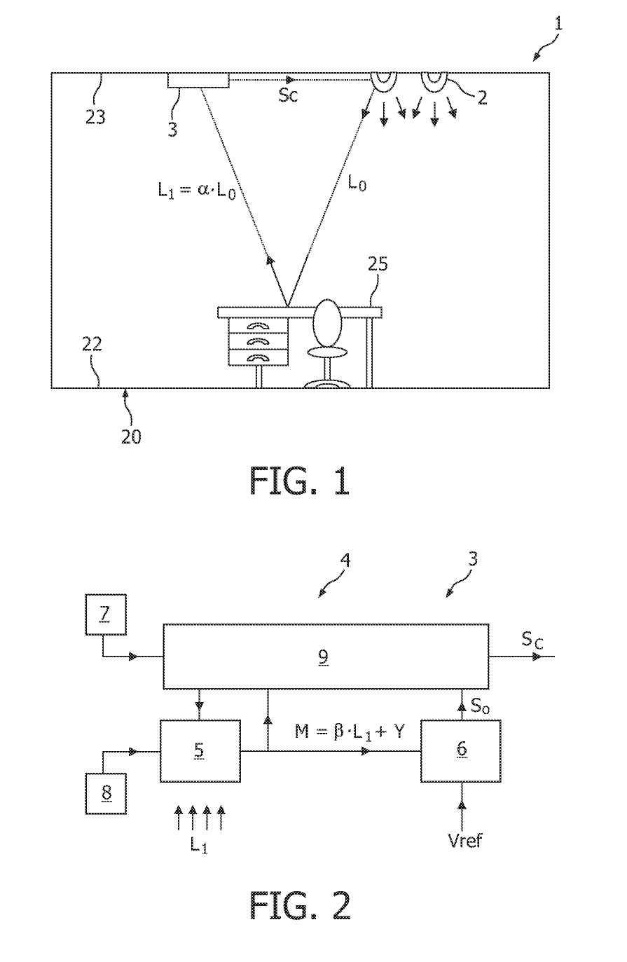

FIG. 1 schematically shows a room 20 with a floor 22 and a ceiling 23. Office furniture is exemplary illustrated as a desk 25. The room is provided with an illumination system 1, which comprises a plurality of controllable light sources 2; in the example of FIG. 1, only two light sources 2 are shown. The light sources may include incandescent lamps, gas discharge lamps, LEDs, or any other suitable type of light source; in the following, the light sources will briefly be indicated as “lamp”.

The illumination system 1 further comprises a control system 3 for controlling the light sources 2; more particularly, the control system 3 is capable of switching the lamps ON, OFF, or of dimming the lamps. Depending on the type of lamps, the control system 3 may comprise lamp switching means such as a power relays, but it is also possible that the control system 3 comprises an output for providing a control signal S_{C} for the lamps, for cases where a lamp comprises a dedicated lamp driver to be controlled by such control signal.

In a particular implementation, the control system 3 is capable of switching the lamps ON or OFF on the basis of the ambient light level and in response to a detector, for instance an infrared movement detector, detecting the presence or absence of any person in the room 20. Suppose that it is desirable that the ambient light level is at least higher than a predetermined threshold level (for instance 500 lux) when there is at least one person in the room. If there are no people in the room, the lights are OFF. If the ambient light level is lower than the threshold level while at least one person enters the room, the lamps are switched ON automatically. For instance, the lamps may provide 500 lux. If, with the lamps ON, the ambient light level is above a second predetermined threshold level (for instance 1100 lux in this example; for instance due to sunlight) while there is at least one person in the room, the lamps are switched OFF automatically (leading to a reduction in light level of 500 lux which leaves, in this example, 600 lux in the room).

In another particular implementation, the lamps are dimmed to a higher or lesser extent, depending on the amount of outside light entering the room, in such a way that the ambient light level is substantially maintained constant (for instance 500 lux). In both implementations, in the second implementation even more so than in the first, it is important that the sensor system is calibrated.

FIG. 2 is a block diagram illustrating that the control system 3 comprises a sensor system 4, comprising a light sensor 5 and a comparator 6, and a controller 9 capable of adjusting the sensor system 4, specifically the sensor 5. The light sensor 5 receives light at a level (or intensity) L1, and generates an output signal M that is proportional to the received light level L1 according to formula (1),

M=β·L1+γ (1)

wherein β indicates a sensor response coefficient, and wherein γ represents a zero-level (offset). The sensor output signal M is received by the comparator 6, which compares the received sensor output signal M with at least one reference value Vref. Depending on the comparison result, the comparator 6 issues an output signal So. The sensor output signal M and the comparator output signal So are received by the controller 9.

The reference value Vref corresponds to a certain light level Lref. In a possible implementation, the operation may be as follows.

If a user enters the room during bright daylight, the daylight received by the sensor 5 may be such that the output signal M is higher than the reference value Vref; in that case, the control system 3 keeps the lamps 2 switched OFF.

When the daylight reduces and hence the output signal M of the sensor 5 gets lower, the output signal M may drop below the reference value Vref; in that case, the control system 3 switches the lamps 2 ON in a dimmed state, such that the combination of daylight and lamp light results in a sensor output signal M corresponding to the reference value Vref.

When the daylight reduces further, the lamps 2 are switched higher to maintain the illumination level. When the lamps, ultimately, are switched ON fully, a further reduction of daylight can no longer be compensated.

When, finally, the user leaves the room, the lamps 2 are switched OFF (typically after some delay).

The problem underlying the present invention is also illustrated in FIG. 1. The actual light intensity of the lamps 2 is indicated as L0. Through reflection, the sensor 5 receives a light intensity L1=α·L0, wherein α represents a “global” reflection coefficient of the room 20, having a value between 0 and 1. In advance, the actual value of α at the application location is not known, and therefore the value of the sensor response coefficient β may be too high or too low.

For solving this problem, the controller 9 is capable of performing an automatic calibration procedure at a moment when the influence of daylight is zero or at least small, and preferably at a moment when there are no people in the room. The calibration procedure comprises two measurements. A first measurement is performed when all lamps are switched OFF. As far as the sensor is concerned, in dark circumstances its output signal M should be zero, therefore, with reference to formula (1), this first measurement satisfies the following formula:

M(1)=β·L1(1)+γ=0 (2)

wherein L1(1) indicates the (unknown) amount of background light.

A second measurement is performed when all lamps are switched ON for 100%. The output signal M should now correspond to the installed light power of the illumination system 1, which is known in the system and which is indicated as L_{INST}. Therefore, with reference to formula (1), this second measurement satisfies the following formula:

M(2)=β·α·(L1(1)+L_{INST})+γ=M_{INST} (3)

wherein M_{INST} indicates the calibrated or expected measurement value when the light level in the room 20 is equal to the installed light power L_{INST} of the illumination system 1.

It is noted that, for performing the second measurement, the lamps need typically to be switched ON during a brief moment of time only. In order to take into account that some types of lamps take some more time to reach the steady-state output level, the controller 9 may be programmed to switch ON the lamps, wait for a predetermined delay time, and then perform the second measurement. This delay time may range from several seconds to several minutes. Alternatively, it is possible to determine a fixed ratio between illumination level immediately after switch-on and illumination level during steady-state, and to take this ratio into account when performing the calibration.

In formula (3), L1(1) and γ may be neglected, M_{INST} is fixed, and L_{INST} is known. α is the unknown reflection coefficient. The controller 9 is designed to amend the sensor response coefficient β such that its measurement signal M(2) equals M_{INST}. Alternatively, if the sensor response coefficient β is a factor too low or too high, it is possible to adjust the reference level Vref by the same factor, so that ultimately the decisions as to switching the lamps ON or OFF are made at the correct ambient light level.

It is possible that γ is taken to be zero. In that case, the sensor output signal will be unequal to zero in response to the (unknown) amount of background light in the case of the first measurement. However, having set β, the controller 9 may be designed to amend the zero-level γ such that the measurement signal M(1) is equal to zero. This will, however, have little or no consequence for the calibrated value of β.

In an illustrative example, the installed light level is equal to 500 lux, the value M_{INST} is equal to 4 V, and there are two reference levels Vref1=4 V and Vref2=10 V. This means that the lamps are switched OFF when the illumination level is equal to or higher than 1250 lux and that the lamps are switched ON when the illumination level is lower than 500 lux.

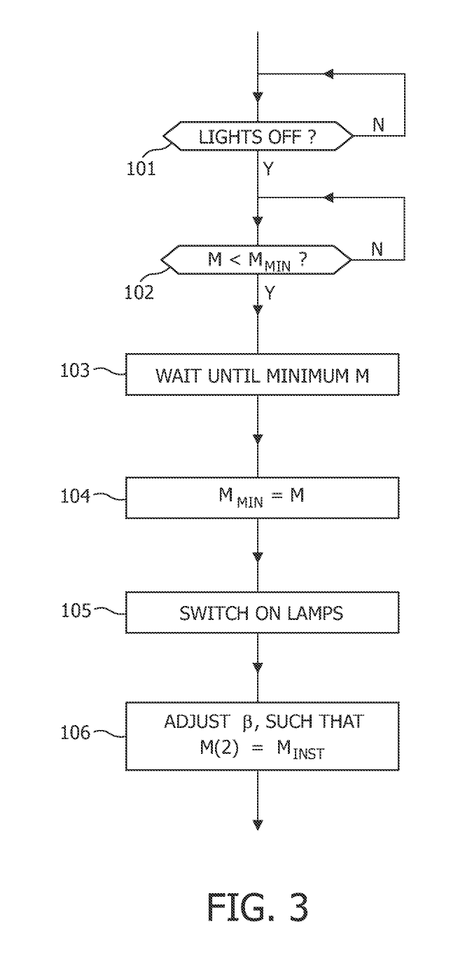

As mentioned above, in the prior art the calibration procedure is initiated by a manual user command, or performed at a fixed time or in response of the illumination level becoming lower than a reference level. According to the present invention, the controller 9 is designed to detect the darkest moment of a day, as will be explained with reference to FIG. 3, which is a flow diagram schematically illustrating the operation of the sensor in determining a suitable starting moment for the calibration procedure.

In a first step 101, the controller 9 checks whether all lights have been switched OFF; this may have been done by the user, or by the controller itself in response to detecting that there are no people left in the room. If the controller 9 finds that all lights have been switched OFF by the user, the controller in step 102 monitors the illumination level, represented by the sensor output signal M, by comparing this with a lowest history value M_{MIN}, stored in a memory location 7 (see FIG. 2). As long as the output signal M remains higher than this lowest history value M_{MIN}, no (new) calibration procedure will be started.

If in step 102 the controller 9 finds that the current measurement value M is lower than the lowest history value M_{MIN}, this indicates that the last calibration was apparently executed at a moment when it was not completely dark, and that now a moment is approaching that it is darker and therefore allowing for a better calibration. In step 103, the controller monitors the decreasing measurement value M (indicating that it is still getting darker), and determines a moment when the measurement value M reaches a minimum value (corresponding to the darkest moment). The controller may do this by waiting until the measurement value M starts rising again, but it is also possible that the controller uses more sophisticated algorithms for calculating the moment of minimum M. It is noted that algorithms for analysing a measurement signal and calculating when it has reached a minimum or maximum are known per se and can be used in implementing the present invention, therefore a more elaborate discussion of such algorithm is not needed here. Suffice it to say that, under normal circumstances, the period of darkness during the evening and night lasts relatively long, so that the decision regarding the precise moment of minimum M is not very critical, it may have a tolerance of several minutes or perhaps even in the order of one hour. In a possible embodiment, the measurement value M is sampled regularly, for instance once per 5 minutes, and the time-derivative dM/dt is calculated as the difference between two successive measurements. As long as the light level is reducing, the time-derivative dM/dt is negative. M can be considered to have reached its minimum if the time-derivative dM/dt changes sign, or if the absolute value |dM/dt| is lower than a predetermined threshold.

At the moment of minimum M, determined in whichever way, the controller 9 in step 104 stores the current value of M as lowest history value M_{MIN} into the memory location 7, and performs a calibration procedure (steps 105-106). The calibration procedure particularly involves the steps of switching ON the lamps 2 (step 105), and adjusting β such that the measurement result M is equal to the predefined value M_{INST} (step 106). It is noted that the first measurement (see formula (2)), may be skipped.

It is noted that the sensor response coefficient β, and optionally also the zero-level γ if this is not fixed to be equal to zero, is stored in a coefficient memory 8 of the sensor 5.

After this calibration procedure, operation of the sensor is as usual: once the user turns on the lamps again, the control system 3 controls the illumination value on the basis of the sensor signals, wherein now the calculation parameter β has a different value.

The above procedure is repeated whenever the lights are switched off, which typically means every evening/night. As long as the previous darkest moment is not improved by a still darker moment, no calibration is performed. If a moment occurs of more darkness that the previous darkest moment, a new calibration is performed at the next minimum of the light level. It is to be expected that, in normal circumstances, the sensor will be suitably calibrated within a few days after installation.

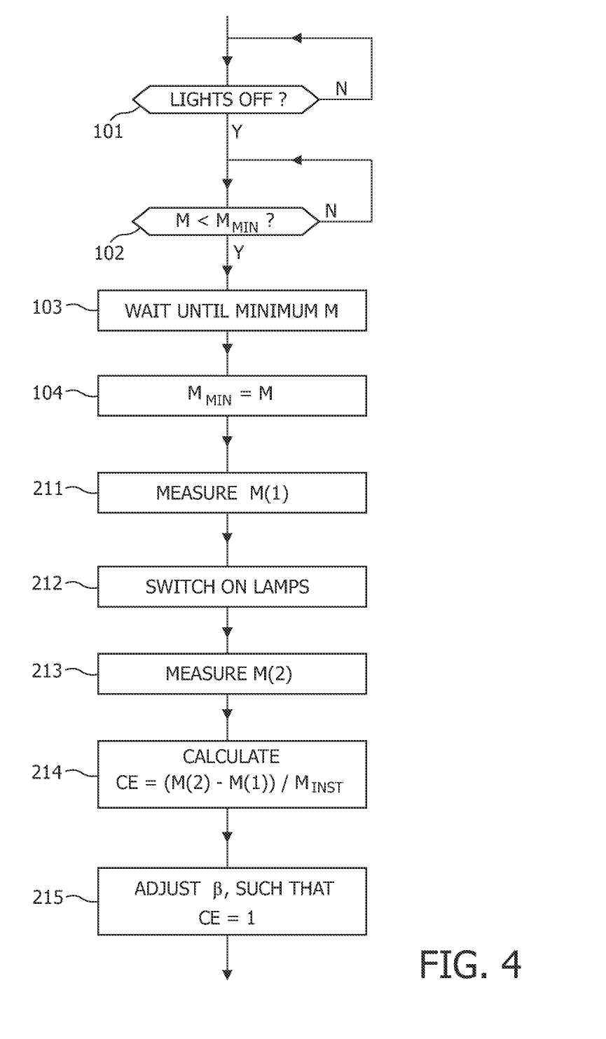

In the above-described embodiment, it is assumed that at the moment of minimum light level it is dark in the room. In that case the result of the second measurement can be used directly for tuning the sensor response coefficient β. However, it may also be that, at the moment when the minimum light level is reached, it is not completely dark in the room. This may, for instance, be caused by light sources outside the room, or for instance by the absence of sunset in a location within a polar circle. The present invention also provides a solution to this problem, illustrated in FIG. 4.

Again, the controller 9 waits until the darkest moment (steps 101-104), and then performs the first measurement with the lights OFF (step 211; see formula (2)) and the second measurement with the lights ON (steps 212-213; see formula (3)). If needed, the sensor response coefficient β is lowered such that the M(2) is within the range of the sensor.

Now the difference M(2)-M(1) should correspond to the predetermined value M_{INST}, according to formula 4:

M(2)−M(1)=β·α·L_{INST}=M_{INST} (4)

To check this, the controller 9 calculates the difference M(2)−M(1), and compares (step 214) this difference with M_{INST}, according to formula 5:

CE=(M(2)−M(1))/M_{INST} (5)

in which CE indicates a calibration error. If the calibration is correct, this calibration error is equal to 1.

In a next step 215, the controller 9 tunes the sensor response coefficient β such that CE becomes equal to 1. If the zero-level γ is taken to be zero, this means that the sensor response coefficient β may be divided by the calibration error CE obtained in step 214. Alternatively, as mentioned before, it is possible that the reference level(s) of the comparator is/are multiplied by the calibration error CE obtained in step 214.

Summarizing, the present invention provides an illumination system 1 which comprises:

at least one light source 2;

a control system 3 for controlling the light sources, the control system comprising a sensor system 4 with at least one light sensor 5 for sensing ambient light L1 and for generating a sensor output signal M representing the sensed light level, wherein the control system is designed for controlling the light sources in relation to the sensor output signal.

The control system automatically calibrates the sensor system.

The control system measures the ambient illumination level M_{MIN} at a moment of calibration and stores this measured ambient illumination level into a memory 7.

The control system monitors the ambient illumination level and compares this with the stored value, and automatically performs a calibration procedure when the ambient illumination level reaches a minimum value lower than the stored value.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, although the sensor 5 and the comparator 6 are shown as separate units, it is possible that these two devices are integrated.

Further, although the comparator 6 and the controller 9 are shown as separate units, it is possible that these two devices are integrated.

Further, instead of adjusting the sensor response coefficient β, it is possible that the controller adjusts the reference level Vref.

Further, it is to be noted that the calibration operation may be performed by the sensor system 4, or by the controller 9 of the control system 3, or by a hierarchically higher controller of the illumination system.

Further, although it is preferred that the monitoring of the ambient light level to find a minimum is performed with the lights switched OFF, it is possible and within the scope of the invention that this monitoring is performed with the lights switched ON.

Further, with respect to FIG. 4, it is possible that the order of the steps 211 and 212/213 is reversed.

Further, it is possible that the system has only one light source.

Further, it is possible that the system is provided with a clock signal, and that the system is programmed to restrict calibration procedures to predefined time windows only, for instance only between 20.00 and 04.00 hours, or only during weekends. Further, it is possible that the system is programmed to avoid a quick repetition of calibrations by respecting a predetermined time interval between two successive calibrations, for instance one hour.

Further, in the above, the invention is explained for a system that automatically switches lamps ON and OFF in response to a presence detection. However, it is also possible that the lamps are switched ON and OFF in response to a user command. If the user switches OFF the lamps at the end of the working day, the monitoring procedure can be as explained with reference to FIGS. 3 and 4, and for performing the measurement it is required that the system briefly switches ON the lamps. However, it is also possible that user leaves the room without switching OFF the lamps. In that case, the calibration procedure can still be performed by detecting a minimum in the ambient light (i.e. skipping step 101 in FIGS. 3 and 4), and for performing the measurement it is required that the system briefly switches OFF the lamps.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Illumination system (1), comprising:
at least one light source (2);
a control system (3) for controlling the light sources (2), the control system (3) comprising a sensor system (4) with at least one light sensor (5) for sensing ambient light (L1) and for generating a sensor output signal (M) representing the sensed light level, wherein the control system (3) is designed for controlling the light sources (2) in relation to the sensor output signal (M);
wherein the control system (3) is designed to automatically calibrate the sensor system (4);
wherein the control system (3) is designed to measure the ambient illumination level (M_{MIN}) at a moment of calibration and to store this measured ambient illumination level into a memory (7);
wherein the control system (3) is designed to monitor the ambient illumination level and compare this with the value (M_{MIN}) stored in said memory (7), and, if the comparison shows that the ambient illumination level is lower than the value (M_{MIN}) stored in said memory (7), to determine when the ambient illumination level reaches a new minimum value and to automatically perform a calibration procedure when the ambient illumination level reaches the new minimum value.

2. System according to claim 1, wherein the control system (3) is designed to calculate the time-derivative (dM/dt) of the sensor output signal (M) and to determine that the ambient illumination level reaches a new minimum value when the time-derivative (dM/dt) is lower than a predetermined threshold.

3. System according to claim 1, wherein the control system (3) has a predefined value (M_{INST}) representing the expected value of the sensor output signal (M) in a situation that the ambient illumination level corresponds to the installed light output of the combined light sources (2);
wherein the light sensor (5) generates the sensor output signal (M) according to the formula
M=β·L1+γ
wherein L1 indicates the ambient light level,
wherein β indicates a sensor response coefficient, and
wherein γ represents a zero-level that may be equal to zero;
and wherein the control system (3) is designed, in the calibration procedure, to:
measure the ambient light with the lights switched OFF to obtain a first measurement result (M(1));
measure the ambient light with the lights switched ON to obtain a second measurement result (M(2));
adjust the sensor response coefficient β such that M(2)−M(1)=M_{INST} is true.

4. System according to claim 3, wherein the sensor system (4) further comprises a comparator (6) receiving the sensor output signal (M) and receiving at least one reference signal (Vref);
wherein the control system (3) is designed, in the calibration procedure, to:
measure the ambient light with the lights switched OFF to obtain a first measurement result (M(1));
measure the ambient light with the lights switched ON to obtain a second measurement result (M(2));
calculate a calibration error (CE) according to:
CE=(M(2)−M(1))/M_{INST}
and, instead of adjusting the sensor response coefficient β, to adjust the at least one reference signal (Vref) by multiplication by CE.

5. System according to claim 1, wherein the control system (3) is designed to check that the light sources (2) are in a switched OFF condition before starting to monitor the ambient illumination level.

6. System according to claim 5, wherein the control system (3) has a predefined value (M_{INST}) representing the expected value of the sensor output signal (M) in a situation that the ambient illumination level corresponds to the installed light output of the combined light sources (2);
wherein the light sensor (5) generates the sensor output signal (M) according to the formula
M=β·L1+γ
wherein L1 indicates the ambient light level,
wherein β indicates a sensor response coefficient, and
wherein γ represents a zero-level that may be equal to zero;
and wherein the control system (3) is designed, in the calibration procedure, to switch ON the light sources (2) and to adjust the sensor response coefficient β such that M=M_{INST} is true.

7. System according to claim 6, wherein the sensor system (4) further comprises a comparator (6) receiving the sensor output signal (M) and receiving at least one reference signal (Vref);
wherein the control system (3) is designed, in the calibration procedure, to switch ON the light sources (2) and measure the ambient light to obtain a measurement result (M);
to calculate a calibration error (CE) according to:
CE=M/M_{INST}
and, instead of adjusting the sensor response coefficient β, to adjust the at least one reference signal (Vref) by multiplication by CE.
